(19) United States
(12) Patent Application Publication
(10) Pub. No.: US 2015/0130195 A1
(43) Pub. Date: May 14, 2015

(54) ELECTRIC LOCK FOR DOORS

(71) Applicant: LI-SHIH LIAO, TAOYUAN COUNTY (TW)

(72) Inventor: LI-SHIH LIAO, TAOYUAN COUNTY (TW)

(21) Appl. No.: 14/532,161

(22) Filed: Nov. 4, 2014

(30) Foreign Application Priority Data
Nov. 8, 2013 (CN) 201310554279.3

(51) Int. Cl. E05B 47/00

(52) U.S. Cl. CPC E05B 47/0001
USPC 292/194

(57) ABSTRACT

An electric lock for doors has a housing with an opening, including a first catch and a second catch, an overlap formed by which enables the operation of the present invention. A blocking element connected to a driving device is displaced between an opening position and a closing position whereby the blocking element would stop the first catch from turning when being in the closing position, therefore controlling the turning of the second catch, rendering the opening a locked status and locking up the latch; when the blocking element is in the opening position, the blocking against the first catch would be eliminated, therefore turning the second catch together and rendering the opening an unlocked status, allowing the latch to be unlocked.

### BACKGROUND OF THE INVENTION

1. Field of the Invention

The present invention relates to a structure of lock, particularly to one that is electrically operated and applied to door locks.

2. Description of the Related Art

Currently the electric locks set on door frames mostly have two sets of corresponding catches inside a housing to form a hedge for a latch to be locked in; meanwhile the two sets of catches are separately connected to a control system to hold control of the opening and closing of the catches. When the lock is locking up, each control system is controlling the connected catches to lock the latch in the hedge; when the lock is unlocking, the control systems are separating the two sets of catches for the latch to leave the hedge.

Furthermore, the conventional electric locks have defects as following. Firstly, with the structures of two control systems, it needs two blocking elements to stop the catches from turning to lock up the latch. The control systems need to operate two blocking elements separately by a solenoid valve in order to eliminate the blocking against the catches so that the catches can turn and unlock the latch to open the door. Such structure is complicated and needs higher costs for production. Also, the two blocking elements need to be operated synchronously; if one of which is malfunctioned, the lock would not be able to operate properly. Secondly, such electric locks usually need higher currents for the solenoid valve to initialize the operation. To avoid the solenoid valve to be overheated, PCB control devices are applied; however, PCB control devices are not durable as the electric locks are, which increases the risks of the locks.

### SUMMARY OF THE INVENTION

The primary object of the present invention is to provide an electric lock for doors with simple structure and low rate of malfunction, and one that needs small currents for initiating with no need of PCB control system.

To achieve the object mentioned above, the present invention comprises a housing for installing related components, having a side wall around, on which there is an opening for a latch to enter; a first catch arranged at one side of said housing, having a first inner arm and a first outer arm, the latter of which is near said opening; a second catch arranged at the other side of said housing correspondingly to said first catch, having a second inner arm and a second outer arm; wherein the end of said second inner arm partially overlaps the end of said first inner arm, forming an overlap, and a hedge for locking the latch is formed by said first and second outer arm; a driving device disposed inside said housing and near the first catch, having a driving stick to stick out and withdraw; and a blocking element to be displaced between an opening position and a closing position by said driving stick; whereby the blocking element would stop the first catch from turning when being in the closing position, and the first catch would stop the second catch from turning due to the arrangement of said overlap, rendering the opening a locked status; when the blocking element is in the opening position, it would allow the first catch to turn and control the turning of the second catch as well, rendering the opening an unlocked status.

The present invention further has a first column and a second column arranged symmetrically inside the housing near the inner corners of said opening, and a first positioning hole and a second positioning hole arranged on the first catch and second catch respectively, near the rim of which a first fillister and a second fillister are arranged respectively; the first and second positioning hole are respectively mounted on the first and second column to set the first and second catch inside the housing, and two torsion springs are disposed separately in said first and second fillister with one side thereof separately abutting the vertical edge of corresponding fillister and the other side thereof abutting the side wall to provide the force for the first and second catch to turn back.

Moreover, the present invention has the ends of the first and second inner arm arranged as complementary stairs for overlapping; the outside edges of the first and second inner arm are blocked by the side wall of the housing to prevent from turning inside; and the first and second outer arm each has a chamfer at the end of the inner side thereof for the latch to leave the hedge formed by the first and second outer arm.

In addition, the housing of the present invention has a depression therein arranged behind the first catch for an elastic element to be fixed inside with the top thereof having the blocking element disposed thereon; the blocking element has a holding surface appropriately blocking the rear of the first catch; and the driving device of the present invention is a solenoid valve and further includes a moving block disposed at the end of the driving stick so that it can displace with the operation of the solenoid valve to place the blocking element in the opening or closing position by controlling the pressing on the elastic element. The blocking element further has a dimple hole, and the moving block has a first contact point and a second contact point arranged in opposite direction for the users to select either of which for operation. When the first contact point is selected for operation, the driving stick sticks out to abut the moving block against the blocking element tightly, pressing the elastic element, and it withdraws to loosen the abutting on the moving block and the pressing on the elastic element; when the second contact point is selected for operation, the driving stick sticks out to put the moving block into the dimple hole to loosen the pressing on the elastic element and withdraws to abut moving block and press the elastic element tightly.

The present invention further has inclined surfaces on the inner side of both ends of the side wall near the opening to ensure the first and second catch to turn outside smoothly, and a cover disposed on the housing to avoid dust falling in. Additionally, the present invention includes a control system that can control the operation of the driving device under either electrically connected or disconnected status.

With the end of the second inner arm partially overlaps the end of the first inner arm, the holding surface of the blocking element would block the rear of the first catch to stop it from turning and thus stop the second catch as well when the blocking element is in the closing position. Consequently the latch is locked up in the hedge formed by the first and second catch, achieving the purpose of locking up. When the blocking element is in the opening position, the holding surface thereof leaves the blocking position and the blocking against the first catch is eliminated, enabling the turning of the first catch and the second catch as well, therefore unlocking the latch and achieving the purpose of unlocking. With the disclosed structures, the present invention only needs to control the first catch with one blocking element for operation, which has advantages of simpler structure and smaller volume comparing with a conventional lock; also, it saves energy since it only needs to control the first catch for operation.

### BRIEF DESCRIPTION OF THE DRAWINGS

FIG. 1 is a top perspective view of the present invention;

FIG. 2 is a sectional view along line 2-2 in FIG. 1;

FIG. 3 is an application example of the embodiment as the first contact point being selected for operation;

FIG. 3A is an application example of the embodiment illustrating the blocking element in the closing position as the first contact point being selected for operation;

FIG. 3B is an application example of the embodiment illustrating the blocking element in the opening position as the first contact point being selected for operation;

FIG. 4 is a perspective view of the embodiment as the second contact point being selected for operation;

FIG. 5 is a partially enlarged view of the area 5 in FIG. 4;

FIG. 5A is an application example of the embodiment illustrating the blocking element in the closing position as the second contact point being selected for operation;

FIG. 5B is an application example of the embodiment illustrating the blocking element in the opening position as the second contact point being selected for operation;

FIG. 6 is a perspective view of the present invention;

FIG. 7 is an exploded view of the present invention;

FIG. 8 is a schematic diagram of the present invention as the blocking element being in the closing position; and

FIG. 9 is a schematic diagram of the present invention as the blocking element being in the opening position.

### DETAILED DESCRIPTION OF THE PREFERRED EMBODIMENT

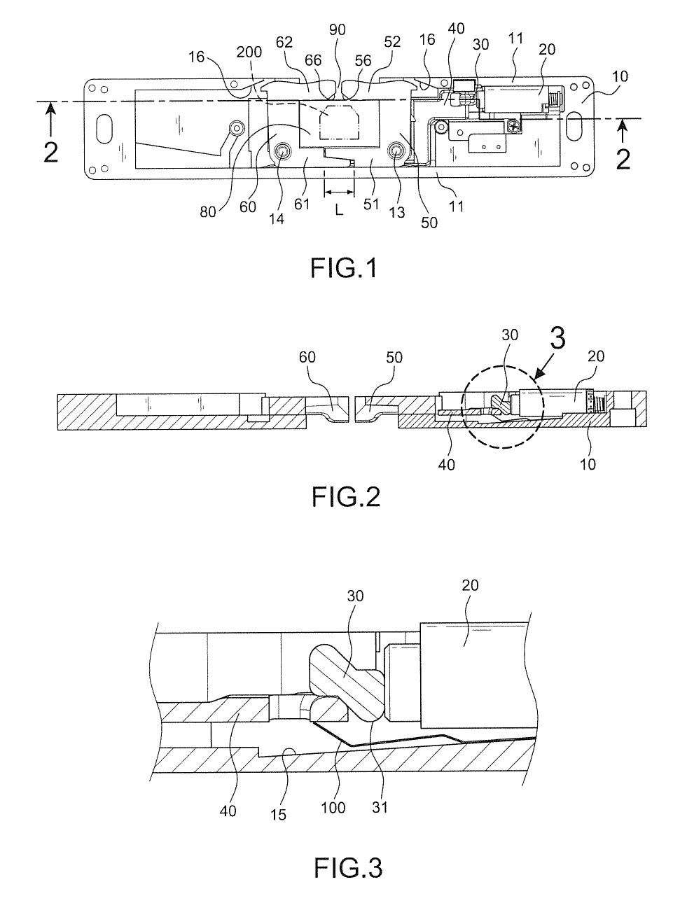

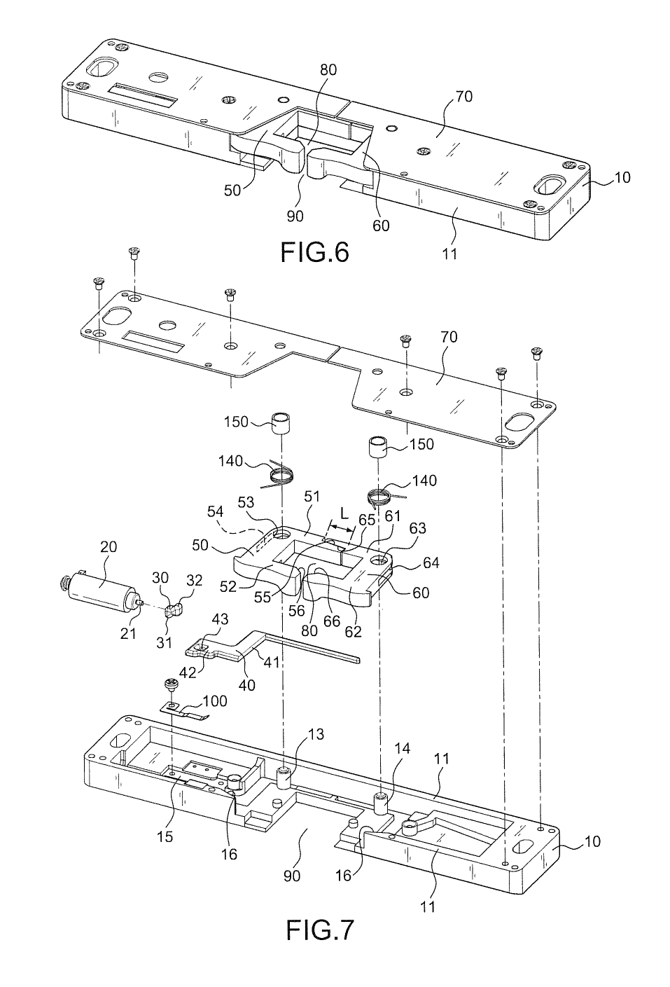

Referring to FIGS. 1, 6 and 7, the present invention comprises a housing 10, a driving device 20, a moving block 30, a blocking element 40, a first catch 50, a second catch 60, and a cover 70.

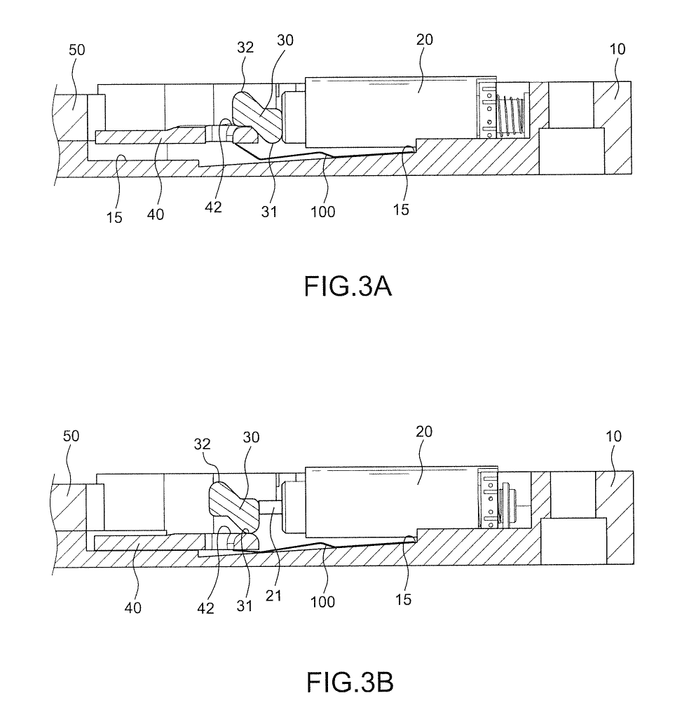

The housing 10 has a side wall 11 surrounding, on which an opening 90 is arranged for a latch 200 to enter; a first column 13 and a second column 14 are arranged symmetrically inside the housing 10 near the inner corners of the opening 90. The cover 70 is disposed on the housing 10 to avoid dust falling in and affect the operation. The first catch 50 has a first inner arm 51, a first outer arm 52, and a first positioning hole 53; near the rim of the first positioning hole 53 a first fillister 54 is arranged. The second catch 60 has a second inner arm 61, a second outer arm 62, and a second positioning hole 63; near the rim of the second positioning hole 63 a second fillister 64 is arranged. The first and second-positioning hole 53, 63 are respectively mounted on the first and second column 13, 14 to set the first and second catch 50, 60 inside the housing respectively and correspondingly on the two sides thereof; wherein the end of the second inner arm 61 partially overlaps the end of the first inner arm 51, forming an overlap L, and a hedge 80 for locking the latch 200 is formed by the first and second outer arm 52, 62. Two torsion springs 140 are disposed separately in the first and second fillister 54, 64, mounted on the first and second column 13, 14 separately by two hollow uprights 150; each torsion spring 140 has one side thereof abutting the vertical edge of corresponding fillister and the other side thereof abutting the side wall 11 to provide the force for the first and second catch 50, 60 to turn back. The driving device 20 is disposed inside the housing 10 near the first catch 50. In this embodiment the driving device 20 is a solenoid valve, having a driving stick 21 to stick out or withdraw by a control system (not shown) for operation under either electrically connected or disconnected status. The moving block 30 is disposed at the end of the driving stick 21 and has a first contact point 31 and a second contact point 32 arranged in opposite direction for the users to select either of which for operation. Furthermore, the housing 10 has a depression 15 arranged therein, behind the first catch 50 for an elastic element 100—in the embodiment, an elastic piece—to be fixed inside, with the top thereof having the blocking element 40 disposed thereon; the blocking element 40 has a holding surface 41 to block the rear 57 of the first catch 50 to stop it from turning, and a contact surface 42 for the first contact point 31 or second contact point 32 thereof to press on. Since the control system (not shown) is controlling the sticking out and withdrawing of the driving stick 21, and the elastic element/elastic piece 100 has the elasticity to be pressed and return, the blocking element 40 is displaced between the closing position as shown in FIGS. 3A, 5A, and 8, and the opening position as shown in FIGS. 3B, 5B, and 9.

FIGS. 2, 3, 3A, and 3B are application examples of the embodiment with the first contact point 31 being selected for operation. FIG. 3A illustrates the control system (not shown) withdrawing the driving stick 21. In this embodiment, the first contact point 31 is not pressing the contact surface 42 of the blocking element 40. Therefore, the elastic element/elastic piece 100 inside the depression 15 is supporting the blocking element 40 to move upwards, resulting in the holding surface 41 thereof blocking the rear 57 of the first catch 50 and stopping it from turning; in this case, the blocking element 40 is in the closing position. FIG. 3B illustrates the control system (not shown) sticking out the driving stick 21. In this embodiment, the first contact point 31 is pressing on the contact surface 42 of the blocking element 40. The blocking element 40 is therefore moved downwards and the holding surface 41 thereof leaves the blocking position and enables the turning of the first catch 50. In this case, the blocking element 40 is in the opening position.

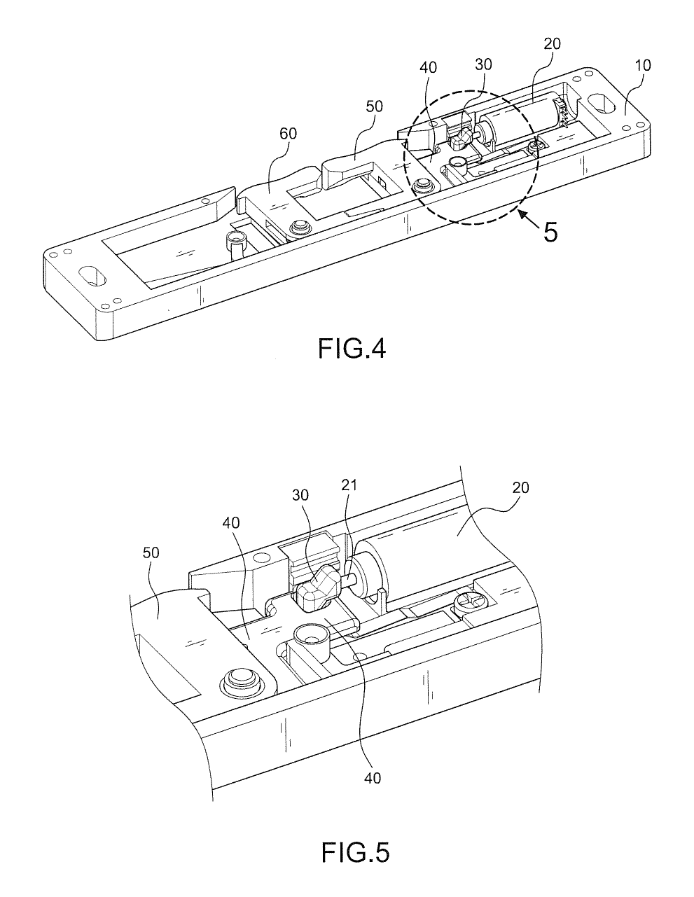

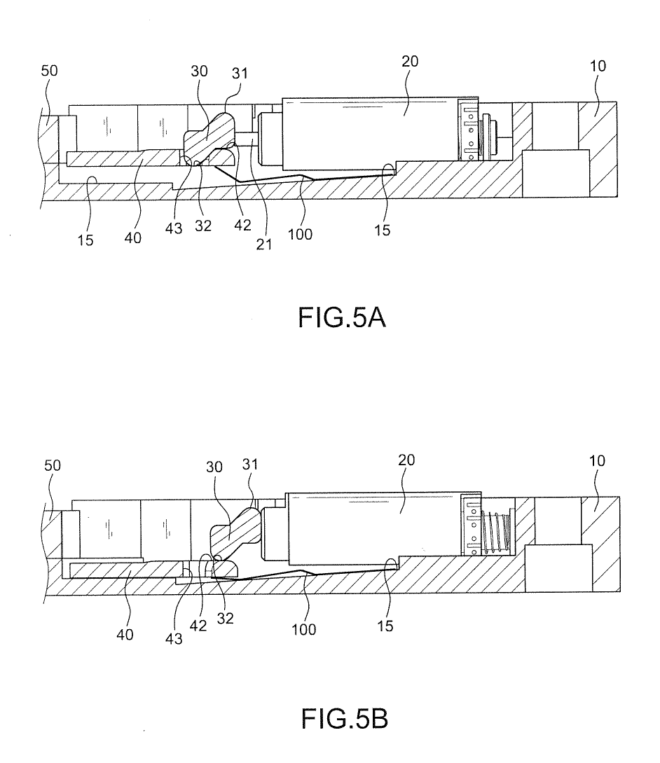

FIGS. 4, 5, 5A and 5B are application examples of the embodiment with the second contact point 32 being selected for operation. FIG. 5A illustrates the control system (not shown) sticking out the driving stick 21. In this embodiment, the blocking element 40 has a dimple hole 43 for the second contact point 32 to be moved therein by the driving stick 21 and stop pressing on the contact surface 42 of the blocking element 40. Therefore, the elastic element/elastic piece 100 inside the depression 15 is supporting the blocking element 40 to move upwards, resulting in the holding surface 41 thereof blocking the rear 57 of the first catch 50 and stopping it from turning; in this case, the blocking element 40 is in the closing position. FIG. 5B illustrates the control system (not shown) withdrawing the driving stick 21. In this embodiment, the driving stick 21 withdraws and results in the second contact point 32 pressing on the contact surface 42 of the blocking element 40, moving it downwards and pressing the elastic element/elastic piece 100 in the depression 15. Therefore, the holding surface 41 leaves the first catch 50 and enables it to turn. In this case, the blocking element 40 is in the opening position.

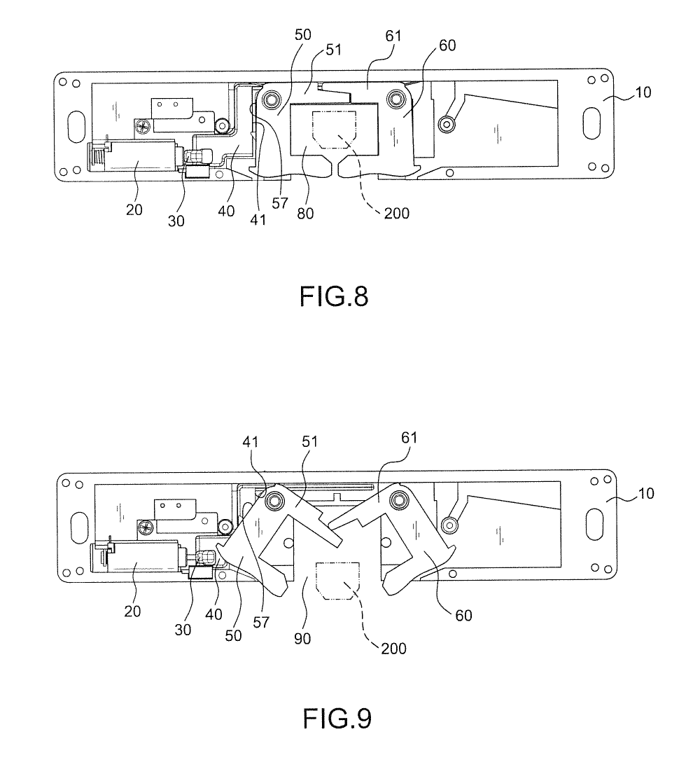

FIG. 8 illustrates the blocking element 40 being in the closing position. The holding surface 41 thereof is blocking the rear 57 of the first catch 50 to stop it from turning and thus stop the second catch 60 as well. Consequently the latch 200 is locked up in the hedge 80 formed by the first and second catch 50, 60, achieving the purpose of locking up.

FIG. 9 illustrates the blocking element 40 being in the opening position. The holding surface 41 thereof leaves the blocking position and the blocking against the first catch 50 is eliminated, enabling the first catch 50 to turn and the second catch 60 as well, and unlocking the latch, achieving the purpose of unlocking.

Further referring to FIGS. 1 and 7, in this embodiment, the overlap L formed by the first inner arm 51 and the second inner arm 61 is arranged as complementary stairs. The first inner arm 51 has a first rabbet 55 engaging a second rabbet 65 of the second inner arm 61 to form a level edge, but the present invention is not limited to such structure. The structure of complementary stairs can reduce the thickness of the overlap L and the volume of the present invention. In addition, the first and second inner arm 51, 61 are blocked by the side wall 11 of the housing 10 to prevent from turning inside; and the first and second outer arm 52, 62 each has a chamfer 56/66 at the end of the inner side thereof for the latch 200 to leave the hedge 80. In this embodiment the present invention further has inclined surfaces 16 on the inner side of both ends of the side wall 11 near the opening 90 to ensure the first and second catch 50, 60 to turn outside smoothly.

In this embodiment the control system (not shown) can control the driving device 20 to operate under either electrically connected or disconnected status. It can be a switch, a processor, or a computer. When opening the door, the control system (not shown) would electrically connect or disconnect the driving device 20 to stick out or withdraw the driving stick 21 in order to move the blocking element 40 in the opening position; consequently the latch 200 leaves the hedge 80 and the door is opened.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An electric lock for doors comprising:
a housing having an opening on the side wall thereof for a latch to enter;
a first catch arranged at one side of said housing, having a first inner arm and a first outer arm, the latter of which is near said opening;
a second catch arranged at the other side of said housing correspondingly to said first catch, having a second inner arm and a second outer arm; wherein the end of said second inner arm partially overlaps the end of said first inner arm, forming an overlap, and a hedge for locking the latch is formed by said first and second outer arms;
a driving device disposed inside said housing and near the first catch, having a driving stick to stick out and withdraw; and
a blocking element to be displaced between an opening position and a closing position by said driving stick;
whereby the blocking element would stop the first catch from turning when being in the closing position, and the first catch would stop the second catch from turning due to the arrangement of said overlap, rendering the opening a locked status; when the blocking element is in the opening position, it would allow the first catch to turn and control the turning of the second catch as well, rendering the opening an unlocked status.

2. The electric lock for doors as claimed in claim 1, wherein a first column and a second column are arranged symmetrically inside the housing near the inner corners of said opening, and a first positioning hole and a second positioning hole are arranged on said first catch and second catch respectively, near the rim of which a first fillister and a second fillister are arranged respectively; the first and second positioning hole are respectively mounted on the first and second column to set the first and second catch inside the housing, and two torsion springs are disposed separately in said first and second fillister with one side thereof separately abutting the vertical edge of corresponding fillister and the other side thereof abutting the side wall to provide the force for the first and second catch to turn back.

3. The electric lock for doors as claimed in claim 1, wherein the ends of the first and second inner arm are arranged as complementary stairs.

4. The electric lock for doors as claimed in claim 3, wherein the outside edges of the first and second inner arm are blocked by the side wall of the housing.

5. The electric lock for doors as claimed in claim 1, wherein the first and second outer arm each has a chamfer at the end of the inner side thereof.

6. The electric lock for doors as claimed in claim 1, wherein the housing has a depression therein arranged behind the first catch for an elastic element to be fixed inside with the top thereof having the blocking element disposed thereon; the blocking element is appropriately blocking the first catch; and the driving device is a solenoid valve and further includes a moving block disposed at the end of the driving stick so that it can displace with the operation of the solenoid valve to place the blocking element in the opening or closing position by controlling the pressing on the elastic element.

7. The electric lock for doors as claimed in claim 6, wherein the moving block has a first contact point and a second contact point arranged in opposite direction, and the blocking element further has a dimple hole; when the first contact point is selected for operation, the driving stick sticks out to abut the moving block against the blocking element tightly, pressing the elastic element, and it withdraws to loosen the abutting on the moving block and the pressing on the elastic element; when the second contact point is selected for operation, the driving stick sticks out to put the moving block into the dimple hole to loosen the pressing on the elastic element and withdraws to abut moving block, and press the elastic element tightly.

8. The electric lock for doors as claimed in claim 1, wherein the present invention further includes a control system that can control the operation of the driving device under either electrically connected or disconnected status.

9. The electric lock for doors as claimed in claim 1, wherein the side wall near the opening has inclined surfaces on the inner side of both ends.

10. The electric lock for doors as claimed in claim 1, wherein the present invention further includes a cover disposed on the housing.
